(19) United States
(12) Patent Application Publication
(10) Pub. No.: US 2004/0248063 A1
(43) Pub. Date: Dec. 9, 2004

(54) Dental tool with deformable grip

(76) Inventors: Boyd I Willat, Los Angeles, CA (US); Adrian Cordova, San Diego, CA (US); Robert C. Portillo, Carlsbad, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/863,564

(22) Filed: Jun. 7, 2004

Related U.S. Application Data
(60) Provisional application No. 60/477,233, filed on Jun. 9, 2003.

(51) Int. Cl. A61C 3/00

(52) U.S. Cl. 433/141

(57) ABSTRACT

A dental tool includes a deformable grip for resiliently conforming to individualized anatomical contours and preferences, thereby providing enhanced user comfort with reduced fatigue. The deformable grip includes a resilient outer sleeve carried on a tool body in a position for fingertip grasping during normal use. The outer sleeve encloses an annular cavity filled at least partially with a deformable or flowable material adapted to undergo substantial localized deformation in response to fingertip pressure for custom fit conformance with the shape of the user's fingertips. In one preferred form, the dental tool is a double-ended instrument carrying a pair of tool components at the opposite ends of the tool body, with a pair of the deformable grips on the tool body proximate said opposite ends for respective fingertip grasping and appropriate custom fit deformation upon respective use of the tool components in the course of performing a dental procedure.

This application claims the benefit of U.S. Provisional Application No. 60/477,233, filed Jun. 9, 2003.

### BACKGROUND OF THE INVENTION

This invention relates generally to improvements in dental tools of the type having at least one tool component such as a dental pick or scraper or the like mounted on an elongated tool body, for use in performing a dental procedure. More specifically, this invention relates to an improved dental tool including at least one deformable grip mounted on the tool body and responsive to user hand and/or fingertip pressure to assume a custom fit shape conforming with individualized anatomical contours and preferences, thereby enhancing user comfort and reducing user fatigue.

Dental tools are known in the art and generally comprise an elongated tool body having a selected tool component mounted at one end thereof, wherein the tool body typically has an elongated and relatively slender size and shape for manual grasping and appropriate manipulation by a dental professional in the course of performing a wide range of dental procedures and tasks. In this regard, single-ended dental tools having a tool component such as a pick, probe, curette, carver, scraper, spatula, mirror or the like mounted at one end of the tool body are widely known and commonly used. Double-ended dental tools having a pair of such tool components mounted at opposite ends of the tools body are also widely known, wherein the pair of tool components can be interchangeably deployed by mere reversal of the tool within the user's hand. Power-driven dental tools having a removable drill bit or other power-driven tool component at one end, and a suitable power-drive connection at a rear or opposite end, are also known in the art.

Proper manipulation and deployment of the dental tool necessarily requires an appropriate grip surface on the tool body for secure and stable manual grasping in the course of performing a selected dental task. In this regard, many dental procedures require a combination of precise and delicate maneuvering with occasional application of substantial fingertip pressure, whereby it is essential for the fingertip-grip interface to accommodate secure and stable grasping and tool positioning substantially without slippage relative to a dental patient's teeth and gum tissues.

In the past, to provide the desirable fingertip-grip interface, dental tools have commonly included roughened or knurled grip surfaces positioned for fingertip grasping during normal tool use. However, such surfaces can still be somewhat slippery, especially when moistened by patient saliva, and wherein this slippage problem is undesirably increased by the use of latex gloves by the dental professional. In addition, despite the presence of a roughened or knurled grip surface, the relatively slender size and shape of the tool body is not conducive to comfortable long-term manual grasping and use without significant user fatigue, as well as incidence of repetitive motion injuries such as carpal tunnel syndrome and the like.

In efforts to address these problems, a variety of improved grips for dental tools have been proposed. Such improved grips have included resilient or elastomeric grip structures adapted for mounting onto the dental tool body, to provide a more comfortable and deformable grip structure positioned for fingertip grasping during tool manipulation and use. See, for example, U.S. Pat. Nos. 5,501,597; 6,322,362; 6,390,818; and 6,471,514. While such deformable grip structures provide improvements in user comfort with reduced fatigue, the resilient nature of the grip structure inherently requires the application of significant manual pressure to deform the grip material each time the dental tool is grasped and used, with the grip material springing back substantially immediately to its initial relaxed or nondeformed state each time the fingertip pressure is released, relaxed, or shifted. In addition, while the grip material is grasped, the resilient material produces substantial reaction forces applied to the user's fingertips urging the grip material to spring back toward the nondeformed state. These factors contribute particularly over an extended period of time to substantial user fatigue and exposure to potential repetitive motion injury.

There exists, therefore, a need for further improvements in and to deformable grips for dental tools, particularly with respect to providing an improved dental tool having a deformable grip designed to achieve substantially optimized user comfort with substantially minimized user fatigue during prolonged use. The present invention fulfills these needs and provides further related advantages.

### SUMMARY OF THE INVENTION

In accordance with the invention, an improved dental tool includes a deformable ergonomic grip for resiliently conforming to individualized anatomical contours and preferences, thereby providing enhanced user comfort with reduced fatigue. The deformable grip is designed for shape deformation in response to relatively light fingertip manual pressure to assume a custom fit geometry uniquely adapted to the individual anatomical contours of the tool user. In the preferred form, the thus-deformed grip is designed for substantial retention of this custom fit deformed shape for a substantial period of time, at least several seconds, before resilient return relatively slowly to an initial substantially nondeformed shape, following release, relaxation, or shifting of the fingertip pressure applied thereto. With this construction, the deformable grip does not produce significant reaction forces applied to the user's fingertips.

In one preferred configuration of the invention, the tool body has an elongated and relatively slender size and shape supporting a tool component at one end thereof in the case of a single-ended tool, and supporting a pair of tool components respectively at opposite ends thereof in the case of a double-ended tool. The tool body defines an annular cavity formed therein at a position generally adjacent to the tool component, with a pair of said annular cavities being formed generally at opposite ends of the tool body in the case of a double-ended tool. A deformable grip is mounted within each of said annular cavities, whereby the deformable grip is thus positioned for convenient fingertip grasping in the course of manipulating and using the adjacent tool component.

The deformable grip comprises a flexible outer sleeve formed from a resilient silicon-based elastomer or the like mounted within the annular cavity on the tool body and cooperating therewith to define an enclosed generally annular chamber. This chamber is at least partially filled with a selected flowable or conformable filler material such as a selected gel or the like for compliant deformation in response to manual pressure, and a selected recovery time following pressure release or relaxation before returning substantially to an initial nondeformed shape. Suitable flowable or conformable filler materials are described in more detail in U.S. Pat. No. 5,000,599 and U.S. Publication US 2003/0051316, published Mar. 20, 2003, both of which are incorporated by reference herein.

The deformable grip responds to relatively light tactile fingertip pressure to undergo shape deformation to assume a custom fit geometry in substantial conformance with the anatomical contours of the user's fingertips. The deformed grip substantially retains this custom fit shape upon pressure relaxation or release, whereby reaction forces tending to return the grip substantially to an initial nondeformed shape are eliminated or minimized. In the preferred form, the filler material is designed to retain the custom fit deformed shape for at least about three seconds or more following relaxation or release of pressure, before returning slowly and substantially to the initial nondeformed shape. In a double-ended tool, one of the deformable grips is positioned for deformation in response to fingertip grasping for use of the tool component at one end thereof, whereas the other deformable grip is conveniently positioned to provide a comfortable structure resting substantially within the notch between the user's thumb and index finger.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view illustrating a double-ended dental tool incorporating a pair of deformable grips in accordance with the present invention;

FIG. 2 is a perspective view of the dental tool of FIG. 1, illustrating manual grasping thereof for use of the dental tool in performing a dental procedure;

FIG. 3 is an enlarged and fragmented perspective view showing the construction of the deformable grip; and

FIG. 4 is an enlarged and fragmented sectional view taken generally on the line 4-4 of FIG. 3.

### DETAILED DESCRIPTION OF THE PREFERRED EMBODIMENT

As shown in the exemplary drawings, an improved dental tool referred to generally by the reference numeral 10 includes at least one deformable grip 12 mounted onto a tool body 14 carrying at least one tool component 16. The deformable grip 12 is designed for secure and stable manual fingertip grasping in the course of manipulating and using the dental tool 10 to perform a selected dental procedure or task. Specifically, the deformable grip 12 is designed for shape deformation in response to relatively light fingertip manual pressure to assume a custom fit geometry uniquely adapted to the individual anatomical contours of the tool user. In the preferred form, the thus-deformed grip 12 retains this custom fit deformed shape for a substantial period of time, at least several seconds, before resilient return relatively slowly to an initial substantially nondeformed shape following release, relaxation, or shifting of the fingertip pressure applied thereto. The deformable grip thus does not produce significant reaction forces applied to the user's fingertips. As a result, user comfort with is substantially optimized, and user fatigue and/or potential for repetitive motion injuries such as carpal tunnel syndrome or the like are substantially minimized.

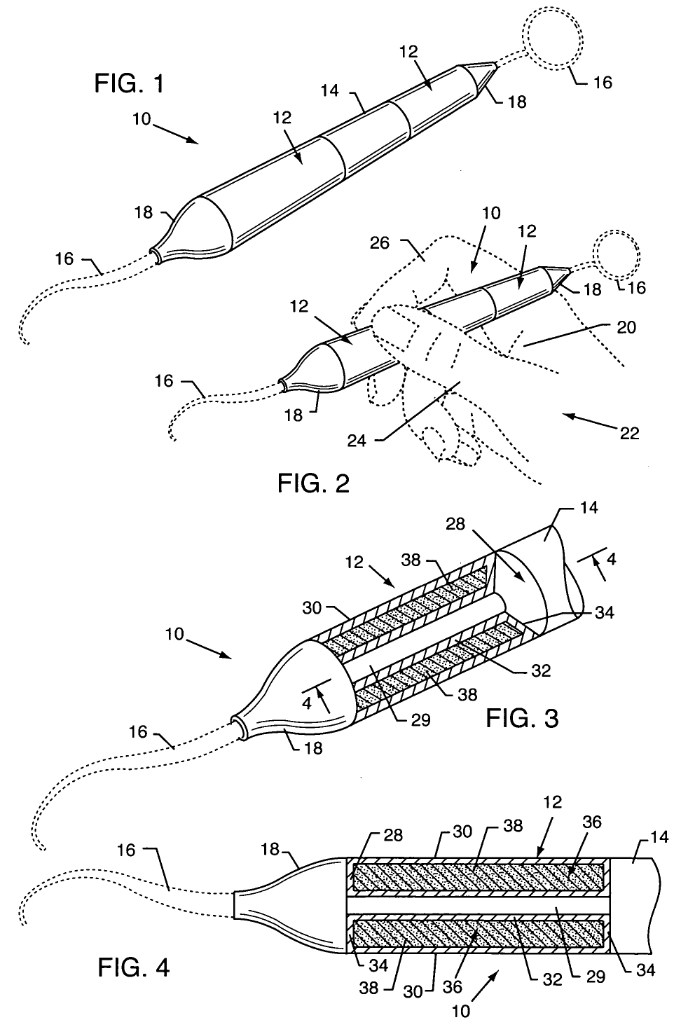

The illustrative drawings show a double-ended dental tool 10 having a pair of tool components 16 mounted at opposite ends of the tool body 14 which has an elongated and relatively slender size and shape. The tool components 16 are shown in dotted lines in FIGS. 1 and 2 to include a dental pick at one end and an angularly oriented dental mirror at an opposite end of the tool body. Tapered nose segments 18 at the opposite ends of the tool body 14 provide a convenient transition structure between the tool body and the associated tool components 16. Persons skilled in the art will recognize and appreciate that a variety of different known dental tool components may be employed, and also that the dental tool may be provided in a single-ended configuration with a tool component 16 mounted only at one end of the tool body 14. It will also be understood that the dental tool may comprise a power-driven tool having a tool component such as a removable drill bit mounted at one end of the tool body.

As shown in the illustrative double-ended tool 10, a pair of the deformable grips 12 in accordance with the invention are mounted onto the tool body 14 at respective positions generally near or adjacent the associated tool components 16. In this regard, as viewed in FIG. 2, the deformable grip 12 associated with the tool component 16 to be used is positioned for convenient and normal manual fingertip grasping by the person using the dental tool 10. Conveniently, the other deformable grip 12 associated with the unused tool component at the rear or opposite end of the dental tool 10 (FIG. 2) is positioned to provide a comfortable and soft structure resting or nested within the notch 20 of the user's hand 22, between the thumb 24 and index or forefinger 26. If and when desired, the double-ended dental tool 10 can be reversed by the user to manipulate and deploy the previously unused tool component, whereupon the pair of deformable grips 12 are also reversed relative to the user's hand 22.

FIGS. 3-4 show the deformable grip 12 in accordance with one preferred form of the invention. As shown, the tool body 14 which is typically constructed from a suitable medical grade material such as anodized aluminum or the like includes an annular recessed cavity 28 formed at a position generally adjacent tapered each nose segment 18, with a narrowed profile stem 29 of the tool body extending coaxially through this recessed cavity 28. The deformable grip 12 comprises a generally cylindrical structure having a size and shape for seated reception into this cavity 28, carried about the stem 29, to provide a resilient structure positioned for fingertip grasping and deformation during tool use.

More specifically, the deformable grip 12 comprises a generally cylindrical outer sleeve 30 formed from a resilient and flexible material such as a silicon-based elastomer or the like. In the exemplary drawings, this outer sleeve 30 is formed as the outward-facing structure of a generally annular-shaped bladder including an inner sleeve 32 and end caps 34 for cooperatively defining a substantially enclosed hollow interior chamber 36. This interior chamber 36 is at least partially filled with a flowable or conformable filler material 38 which provides the deformable grip 12 with the desired combination of shape deformation characteristics. Alternately, the outer sleeve 30 may be suitably mounted onto the tool body 14 for cooperating therewith to define a substantially enclosed annular chamber filled at least partially with the filler material 38.

The filler material 38 comprises, in one preferred form, a fluid or fluidized or conformable substance such as a relatively viscous liquid or gel suitable for movably responding to fingertip or tactile pressure applied to the outer sleeve 30 during normal use of the dental tool 10. The filler material 38 desirably accommodates shape deformation of the grip 12 in response to relatively light or minimal manual pressure, and is designed for substantially retaining the deformed shape upon relaxation, release or shifting of the applied manual pressure. A preferred filler material will substantially retain the deformed shaped for at least about three seconds or more, before returning slowly toward its initial nondeformed shape, upon pressure release. With this construction, the deformable grip comfortably assumes a custom fit ergonomic shape when grasped, but does not apply any significant and potentially fatiguing reaction force to the user's fingertips. While a variety of different filler materials may be used, exemplary materials are shown and described in U.S. Pat. No. 5,000,599 and U.S. Publication US 2003/0051316, published Mar. 20, 2003, both of which are incorporated by reference herein.

The improved dental tool 10 of the present invention thus provides the deformable grip 12 for secure and stable fingertip grasping in the course of manipulating and deploying the associated tool component 16 to perform a selected dental procedure or task. The grip 12 deforms to a custom fit anatomical contour in response to relatively light tactile pressure, and in the preferred form retains the custom fit deformed shape for at least a minimum time period following release or relaxation of the applied fingertip pressure, prior to relatively slow recovery toward the initial nondeformed shape. With this construction, the grip 12 does not provide significant and potentially fatiguing reaction forces to the user's fingertips.

A variety of further modifications and improvements in and to the improved dental tool 10 of the present invention will be apparent to those persons skilled in the art. Accordingly, no limitation on the invention is intended by way of the foregoing description and accompanying drawings, except as set forth in the appended claims.

What is claimed is:

1. A dental tool, comprising:
an elongated tool body having first and second opposite ends;
at least one dental tool component carried by said tool body at at least one of said first and second opposite ends; and
at least one deformable grip on said tool body in a position for manual grasping during use of the dental tool, said deformable grip including a generally cylindrical outer sleeve formed from a flexible material, said outer sleeve encasing a conformable filler material adapted for shape deformation in response to applied manual pressure whereby the shape of said deformable grip changes from an initial nondeformed shape to a substantially custom fit deformed shape corresponding substantially with the anatomical contours of the tool user.

2. The dental tool of claim 1 wherein said tool body defines a recessed annular cavity at a position generally adjacent said at least one tool component, and further wherein said at least one deformable grip is seated within said cavity.

3. The dental tool of claim 1 wherein said at least one deformable grip comprises a generally cylindrical bladder structure including said outer sleeve coupled to an inner sleeve to define a substantially enclosed chamber having said flowable filler material encased therein.

4. The dental tool of claim 1 wherein said filler material comprises a gel.

5. The dental tool of claim 1 wherein said filler material is adapted for deformation in response to relatively lightweight manual pressure applied to said outer sleeve, and for retaining said deformed shape upon release of applied manual pressure for a time interval of at least about three seconds before returning substantially to said initial nondeformed shape.

6. The dental tool of claim 1 wherein said at least one dental tool component comprises first and second dental tool components carried by said tool respectively at said first and second opposite ends, and further wherein said at least one deformable grip comprises first and second deformable grips on said tool body at positions for respective manual grasping during use of said first and second tool components.

7. The dental tool of claim 6 wherein, upon manual grasping of said first deformable grip during use of said first tool component associated therewith, said second deformable grip is positioned to nest comfortably within the notch between the thumb and forefinger of a user's hand, and vice versa.

8. A dental tool, comprising:
an elongated tool body having first and second opposite ends;
first and second dental tool components carried by said tool body respectively at said first and second opposite ends; and
first and second deformable grips on said tool body in respective positions for manual grasping by a user's fingers during use of said first and second tool components to perform a dental task, each of said first and second deformable grips including a generally cylindrical outer sleeve formed from a resilient and flexible material and encasing a conformable filler material adapted for shape deformation in response to applied finger manual pressure whereby the shape of each of said first and second deformable grips changes from an initial nondeformed shape to a substantially custom fit deformed shape corresponding substantially with the anatomical contours of the tool user's fingers;
said second deformable grip being positioned on said tool body to nest comfortably within the notch between the thumb and forefinger of a user's hand upon finger grasping of said first deformable grip, and vice versa.

9. The dental tool of claim 8 wherein said tool body defines first and second recessed annular cavities at respective positions generally adjacent said first and second tool components, and further wherein said first and second deformable grips are seated respectively within said first and second cavities.

10. The dental tool of claim 8 wherein said first and second deformable grips each comprise a generally cylindrical bladder structure including said outer sleeve coupled to an inner sleeve to define a substantially enclosed chamber having said flowable filler material encased therein.

11. The dental tool of claim 8 wherein said filler material comprises a gel.

12. The dental tool of claim 8 wherein said filler material is adapted for deformation in response to relatively lightweight manual pressure applied to said outer sleeve, and for retaining said deformed shape upon release of applied manual pressure for a time interval of at least about three seconds before returning substantially to said initial nondeformed shape.
